(19) United States
(12) Patent Application Publication
(10) Pub. No.: US 2008/0133513 A1
(43) Pub. Date: Jun. 5, 2008

(54) Systems and Methods for Providing, Accessing and Returning Results on Advertising and Service Opportunities

(75) Inventors: Marianne Linde, Austin, TX (US); Lori Dickey, Austin, TX (US)

Correspondence Address: FISH & RICHARDSON P.C., P.O BOX 1022, Minneapolis, MN, 55440-1022, US

(73) Assignee: TRINITY ALLIANCE CORPORATION, Austin, TX (US)

(21) Appl. No.: 11/565,572

(22) Filed: Nov. 30, 2006

(51) Int. Cl. G06F 17/30

(52) U.S. Cl. 707/6; 707/E17.069

(57) ABSTRACT

Systems and methods are provided to match facilitate advertising relationships among various advertising clients and non-profit organizations. In one embodiment, a web-connected database is employed to find non-profit programs or events that match parameters for desired advertising campaigns. Other embodiments may provide campaign records that match parameters of a non-profit organization's desired program or event. Formatted reports and chat capability may help facilitate the entities entering an advertising relationship. Database records and search parameters are provided to facilitate identifying beneficial opportunities. Methods are also provided for a third party provider to operate a server system and receive records of advertising client campaigns and non-profit organization programs or events.

### BACKGROUND

Businesses that wish to advertise products or services may typically employ a marketing department or marketing firm to design and place advertisements in various media such as television, newspapers, web pages, signs, and other promotions. Advertisers often seek to target a specific segment of the population with particular advertising or build a particular brand name with a particular population segment. Advertisers often perform customer relationship management and have community affairs departments to manage their image within particular communities.

Non-profit organizations are often formed with the goal of servicing a particular community or coordinating efforts directed toward a common goal. Non-profits often coordinate events or seminars directed toward their goals, and seek sponsorship of those events, programs and training seminars. Corporate advertising and public relations departments do not always, however, match their advertising and public relations spending effectively with their need to target specific population segments.

What is needed, therefore, is systems and methods to provide advertisers and non-profit organizations the ability to match their corresponding needs and opportunities and best utilize their budgets and donations. What also is needed are systems and methods to facilitate ongoing communications among such advertisers and non-profits throughout their advertising lifecycle.

### SUMMARY

Systems and methods are provided to match and facilitate advertising relationships among various advertising clients and non-profit organizations. In one embodiment, a web-connected database is employed to find non-profit programs or events that match parameters for desired advertising campaigns. Other embodiments may provide campaign records that match parameters of a non-profit organization's desired program or event. Formatted reports and chat capability may help facilitate the entities entering an advertising relationship. Database records and search parameters are provided to facilitate identifying beneficial opportunities. The collaborative nature of the technology allows for the creation of new opportunities from feedback among funding sources, advertisers and non-profit organizations. The first application of this technology has created a targeted media vehicle for reaching Hispanic consumers.

Methods are also provided for a third party provider to operate a server system and receive records of advertising client campaigns and non-profit organization programs or events. Program, event, or campaign matches are identified and transmitted to the requesting advertiser or non-profit. Some embodiments may employ provider administrators to operate the search, edit search results reports, and transmit the reports to the clients.

The technology preferably utilizes Google's search appliance and additional third party software to provide robust internet searching for funding sources that will enhance each opportunity. The system may leverage customer's existing systems to provide relevant data matches from internal customer relationship management systems, business intelligence systems, employee directories, financial systems, homegrown or mission critical systems.

Preferably, systems integration with debit cards provide on line and retail purchase tracking of non-profit client spending patterns and system issues affinity credit cards for same of donors and volunteers of non-profit organizations.

Formatted results may also be displayed on mobile platforms.

Preferably, the system allows consumers to select and purchase programs and services posted by non-profit organizations. This aspect of the system may enhance the community building nature of the technology.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a block diagram of a non-profit advertising opportunity provider system according to an embodiment of the present invention.

FIG. 2 depicts a block diagram of a system server and database application according to one embodiment of the present invention.

FIG. 3 depicts a flow chart for entity registration according to one embodiment of the present invention.

FIG. 4 depicts a web page interface according to one embodiment of the present invention.

FIG. 5 depicts another web page interface for entity registration according to another embodiment.

FIG. 6 depicts a flow chart for non-profit login according to one embodiment of the present invention.

FIG. 7 depicts another web page interface according to another embodiment.

FIG. 8 depicts a web page interface according to another embodiment.

FIG. 9 illustrates an outline format of a sample non-profit organization program profile data form to be filled in by NPO users.

FIG. 10 illustrates an outline format of a sample Trinity Alliance administrator approval of non-profit organization data form to be filled in by administrative users.

FIG. 11 depicts a flow chart for client login and use according to one embodiment of the present invention.

FIG. 12 depicts a web page interface according to another embodiment.

FIG. 13 depicts a web page interface according to another embodiment.

FIG. 14 illustrates an outline format of a sample client campaign profile data form to be filled in by client users.

FIG. 15 depicts a flow chart of a central matching application according to another embodiment.

FIG. 16 depicts a flow chart for a central matching application according to another embodiment.

FIG. 17 illustrates an outline format of a sample Matching Program Parameters Data form.

FIG. 18 illustrates a supporting mapping table between campaign categories and NTEE codes.

FIG. 19 depicts one example of a formatted program matching report.

FIG. 20 depicts one example of a formatted E-Connection report.

FIG. 21 is a block diagram of an Entity Profile Record.

Like reference symbols in the various drawings indicate like elements.

### DETAILED DESCRIPTION

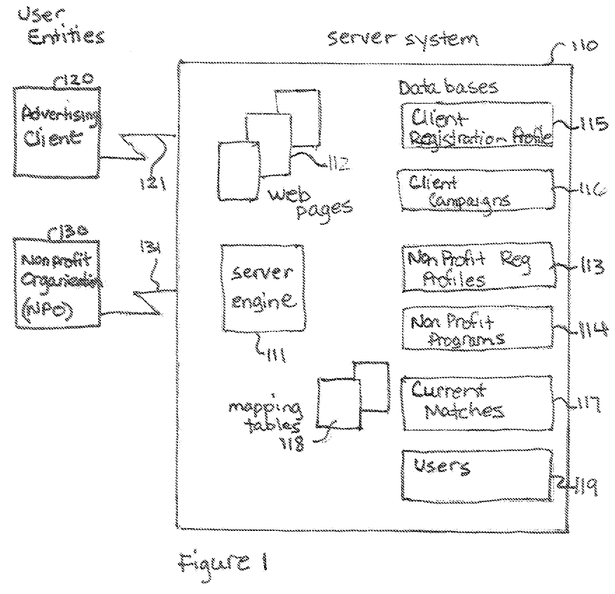

FIG. 1 shows a block diagram of a non-profit advertising opportunity provider system according to an embodiment of the present invention. This embodiment supports an advertising-based business model for non-profit organizations. The depicted server system 110 is provided to receive advertising requests from advertising clients 120 and match those with records of advertising opportunities received from non profit organizations 130. Server system 110 is preferably owned and operated by a third party service provider (provider). Server system 110 includes a server engine 111, various web pages 112, a non-profit registration profiles database 113, a non-profit programs database 114, an advertising company (client) registration profiles database 115, a client campaigns database 116, a current matches database 117, and various mapping tables 118. The server engine 111 receives HTTP requests to access web pages identified by URLs and provides the web pages to the various user entities' systems.

In this embodiment, non-profit organizations register with the system 110 to offer opportunities to advertise through their programs and events. Each non-profit organization (non-profit, NPO) employs a computer system with a browser or other access software to interact with system 110. NPOs may also interact with system 110 on a provider terminal designated for client use. The non-profit registration profiles database 113 contains an entry for each NPO that has registered.

Data provided by the NPOs is also stored. For example, NPOs may enter data regarding the various non-profit programs that they provide such as, for example, offering classes or educational material available to a certain target population in need of such education. Programs also offer a variety of other things such as services, information, and financial aid or other aid, for example. Typically, NPOs provide programs, which are typically an ongoing set of services and materials. NPOs also may provide events, which may involve the same goals, services, and materials as an ongoing program but are typically limited to scheduled times. NPOs may provide other services or materials and may therefore offer advertisers access into such services and materials through various embodiments. For example, an NPO may have a website through which a certain service population may access or submit information. Such a website may be designated as a program in one embodiment,

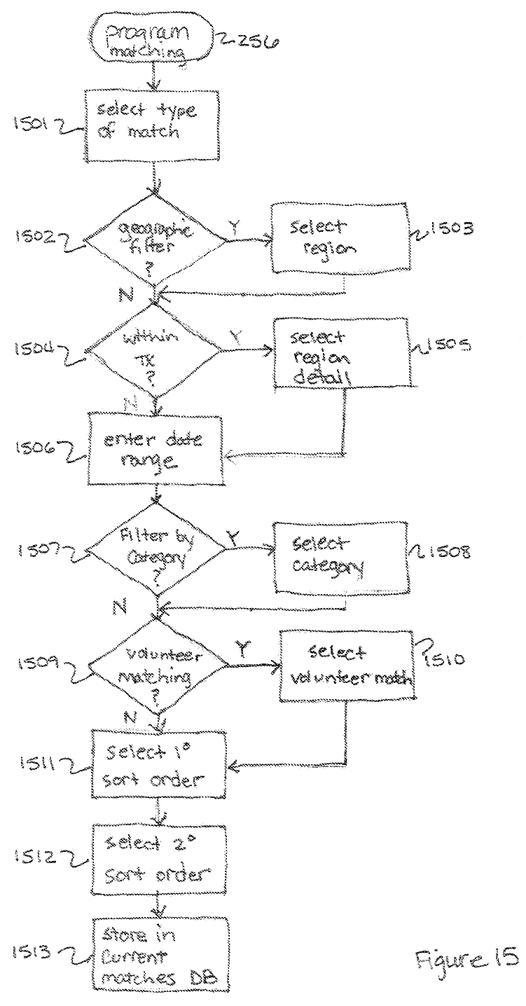

The non-profit programs database 114 contains entries for each program that the NPO has entered for potential matching to advertiser needs. In this embodiment, such entries exist in a child relationship to the parent registration profile. Further, advertising clients 120 also register with system 110 to find opportunities that match their advertising needs. The client registration profiles database 115 contains an entry for each advertising client system 120 (client) that has registered. The client campaigns database 116 contains entries for each advertising campaign that the client has entered for potential matching with non-profit advertising opportunities. These entries exist in a child relationship to the parent registration profile. The current matches database 117 stores entries created by a matching application or code segment, and is further described with reference to FIGS. 15-18. Mapping tables 118 store information to assist the matching application in creating the matches. The user database 119 stores entries created by specific users which are associated with a specific entity registration profile.

Clients 120 typically access system 110 through a browser. The server and client systems interact by exchanging information via communications link 121, which may include transmissions over the internet. The NPO's system 130 behaves similarly and the server and NPO systems interact by exchanging information via communications link 131, which may include transmissions over the Internet.

In this embodiment, the server is implemented using an L.A.M.P. software bundle. Presently preferred versions of platform elements are; Linux—Red Hat v 9.0, the operating system; Apache—v 2.0.xx, the Web server; MySQL v 4.1.7, the database management system (or database server); PHP v 4.2.2, a reflective programming language. While an Apache/MySQL server configuration is preferred, other server platforms may be used such as, for example, Microsoft .Net® application servers, or other types of web servers.

In some embodiments, a chat form may exist to allow users to electronically discuss plans or details of current programs or campaigns or possible future programs or campaigns, or other relevant topics. The threads of these discussions may be saved in a searchable chat form database with links to the user records and their associated client or NPO.

In other embodiments, a section for e-commerce may be included. In this new section, the general public will have access to links to the provider's partners, clients and other associates. The general public, through web pages and links, may be able to purchase goods or services from the NPO or client partners, as well as make donations or other financial transactions. Tracking of the customer leads via “cookies” and implementing online consumer survey capabilities may also be employed.

In still other embodiments a Wiki for general sharing of non-profit knowledge and expertise may be added. The wiki provides capability for visitors to easily add, remove, and otherwise edit some available content, sometimes without the need for registration.

While one server system is shown, different websites may be hosted on one system to serve different communities. For example, non-profit organizations that serve a particular service population or goal, such as, for example, the Hispanic population or the goal of environmental protection, may be grouped in one database on system 110 and provided with a separate domain name and website interface from other groups of organizations.

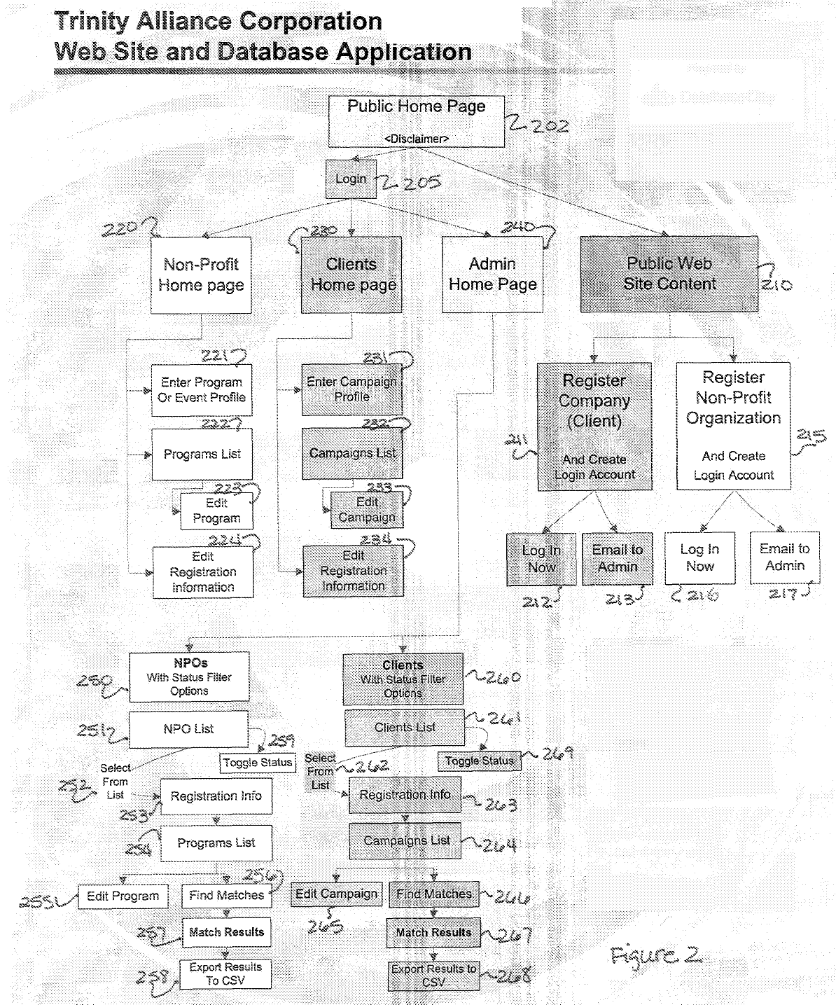

FIG. 2 depicts a block diagram of a system 110 server and database application according to one embodiment of the present invention. In this embodiment, a user requests to access the through a provider's home page 202 such as the depicted public Trinity Alliance home page 202 identified by a URL. Trinity Alliance (TA) is the assignee of the present invention and is the source of several example provider web pages and other example material herein. The user can navigate among several public web sites 210 identified by various URLs. In one embodiment, one or more public pages have essential links presented as text links to registration entry pages for clients 211 or non-profits 215. The user may register their entity and create an account using the appropriate entity registration form page. When the registration form is submitted, login (212 or 216) redirects users to their particular designated entity TA home page. At that same time, an email notification (213 or 217) may be sent to the Trinity Alliance administrator. Returning registered users of registered entities may use the login 205 function directly accessed on the public TA home page 202.

In one embodiment, a returning registered NPO user may login and automatically be directed to their NPO TA Home page 220. This page presents the user with links to visit other pages and perform requested functions. The depicted links are a form page to enter a program or event profile 221, a programs list page link 222 to view program and event records existing in the system, and a form page to edit existing registration information 224. The programs list page may have a select link to allow selection for editing 223 and checking the status of those programs,

In one embodiment, a returning registered client user may login and automatically be directed by system 110 to their client TA home page 230. The client user may then choose to visit the following: a form page to enter a campaign profile 231, a campaigns list page 232 to view which campaign records exist in the system, or a form page to edit existing registration information 234, The programs list page may have a select link to allow selection for editing 233 and checking the status of campaigns. In this embodiment, the Trinity Alliance administrator interfaces with the system through the Admin Home Page 240. Preferably, admin users have a choice of selection buttons to access client information 260 or NPO information 250.

When 260 client is chosen, the page may have status filter capability which allows user to choose among Active Listings (those which are currently available in the system for matching), Inactive Listings (those not currently available), Pending (those whose status of active or inactive has not yet been determined), or Show All Listings. The admin user may also filter by category. The resulting list, after filtering, is shown in client list 261. Each client file may be individually selected 262 with the associated registration information being retrieved from the client registration profile database 115. The status of a client and the associated campaigns may be changed to active or inactive via a toggle switch 269. In this embodiment, because of the parent-child relationship between organizations and their profiles, when an organization is made inactive, all their profiles become inactive, and when they are later made active, all of their programs become active. When the active clients list is requested and returned 261, the admin has access and ability to: edit registration information 263, select from campaigns 264 and edit selected campaign 265, and find matches by selecting search parameters and sort order setup in the matching process 266.

In the depicted system in FIG. 2, when 250 NPO is chosen, the page may have status filter capability which allows user to choose among Active listings (those which are currently available in the system for matching), Inactive Listings (those not currently available), Pending (those whose status of active or inactive has not yet been determined), or Show All Listings. The admin user may also filter by NTEE Code. The National Taxonomy of Exempt Entities (NTEE) is a definitive classification system for nonprofit organizations recognized as tax exempt under Internal Revenue Code 501(c)(3). The resulting list, after filtering, is shown in NPO List 251. Each NPO file may be individually selected 252 with the associated registration information being retrieved from the NPO registration profile database 114. The status of a NPO and the associated programs may be changed to active or inactive via a toggle switch 259. Again, in this embodiment, when an organization is made inactive, all their profiles become inactive, and when they are later made active, all of their programs become active. When the active NPO's list is requested and returned 251, the admin user has access and ability to: edit registration information 253, select from programs 254 and edit selected program 255, and find matches by selecting search parameters and sort order setup in the matching process 256.

The matching process is further explained in FIGS. 15-18. the matching results are then displayed 267, stored in the current matches database 117 (FIG. 1), and the admin user has the option to export the matching results to a CSV file. One skilled in the art will recognize that the comma-separated values (or CSV) file format is a delimited data format that has fields separated by the comma character and records separated by new-lines. CSV is one implementation of the delimiter-separated values file format, which can use any character as the delimiter. Other export formats may be used.

In other embodiments, a general query function may be available to system 110 administrators. This option may allow sorting of the databases by any field available within the given database.

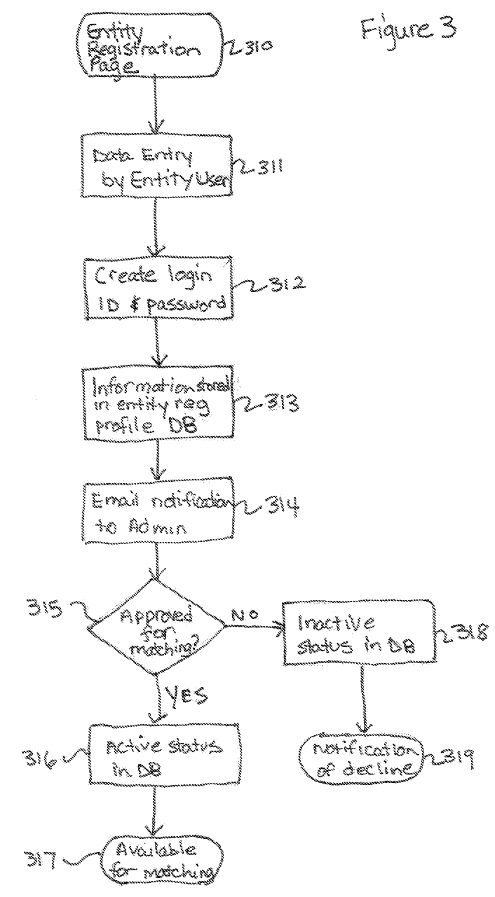

FIG. 3 depicts a flow chart for entity registration according to one embodiment of the present invention which may, for example, implement steps 211 or 215 (FIG. 2). An entity may be either a client or an NPO, The entity may come to the appropriate registration page 310 from public web site 210 (FIG. 2). Data entry takes place by user on the registration form 311. Login ID and password are created by user 312. The login ID, password and registration form data are stored in the Entity Registration Profile database 313. The entity status for matching is “pending.” Concurrently, one or more provider's administrative personnel are notified by email 314. The provider's administrator then researches the entity to determine suitability for matching based 315 on predetermined guidelines. If the entity is suitable for matching, the status is changed to “active” in the database 316 and the entity is available for matching 317. If the outcome of decision 315 is that the entity is not suitable for matching, then status is changed to “inactive” in the database 318 and the entity is notified that it was declined 319.

In other embodiments, the predetermined guidelines used by the admin may include data fields for entering the subscription expiration date, stored in the client registration database. The system may generate emails to the client notifying client of upcoming expiration date and reminding client to renew subscription.

In other embodiments, each entity registered may have multiple users with multiple login IDs and passwords associated with those login IDs. These may be stored in the user database, in a parent-child relationship with the entity registration profiles. In still other variations, data may be automatically retrieved from business partner websites, suitability automatically calculated and status automatically determined and updated.

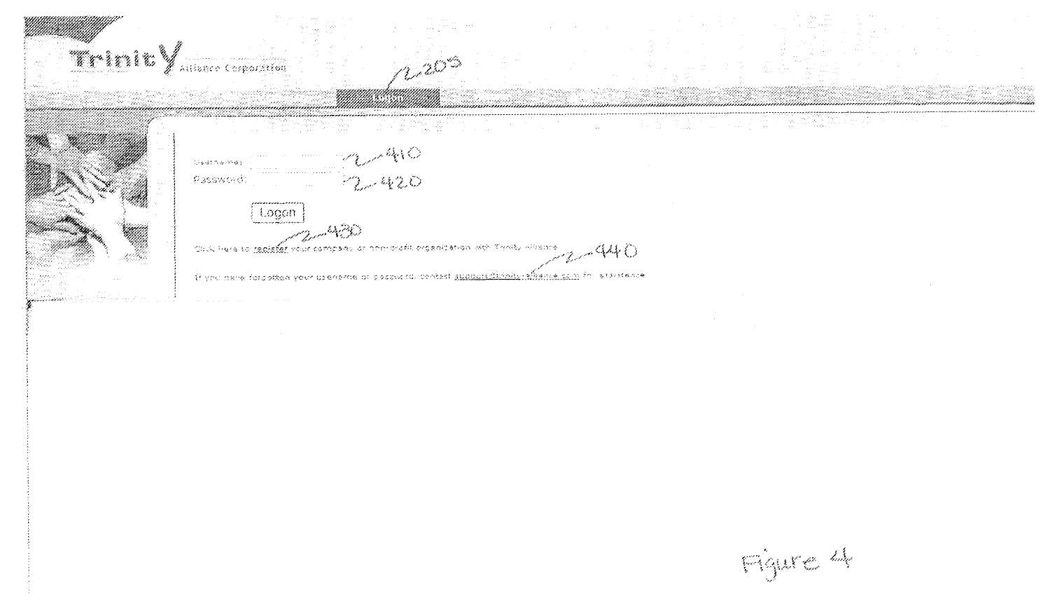

FIG. 4 depicts a web page interface according to one embodiment of the present invention which may, for example, implement step 205 (FIG. 2). Web page interface 205 (FIG. 2) may have a username data field 410 and password data field 420.

If the user and entity have not registered a simple text link 430 will transfer to registration entry pages for clients 211 (FIG. 2) or non-profits 215 (FIG. 2) for registration. If user has forgotten username or password, or is experiencing login difficulties, simple text link 440 allows for email notification of support staff. A person of skill will recognize that this embodiment depicts one exemplar view and other embodiments may have separate pages for clients and non-profit logins (or logon), login capability from other web page interfaces or other exemplar screens.

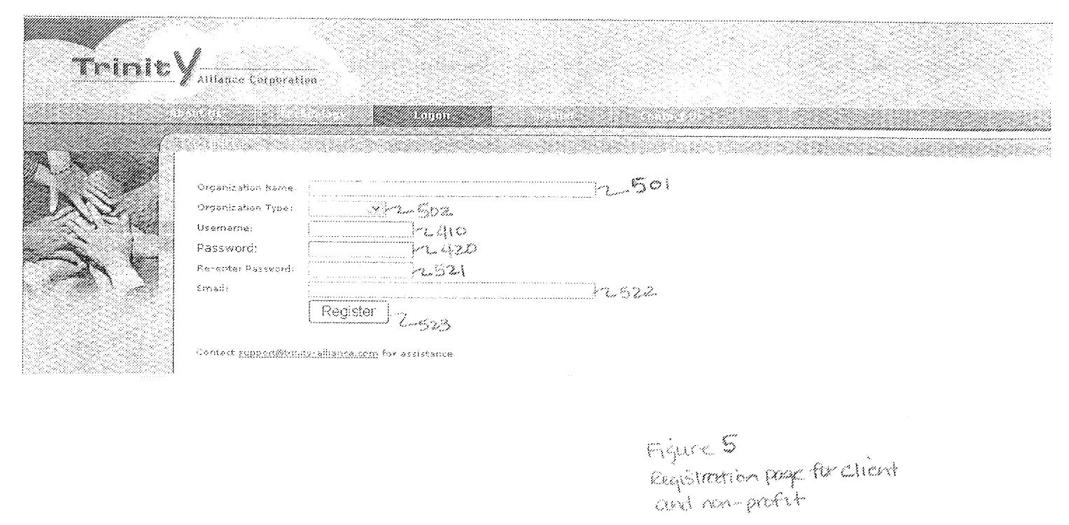

FIG. 5 depicts a web page interface for entity registration according to one embodiment of the present invention which may, for example, implement steps 211 or 215 (FIG. 2). Text box 501 is a data field where user enters organization name. Box 502 provides a menu or drop down select box for organization type. Box 410 (FIG. 4) is a username data field and 420 (FIG. 4) depicts a password data field. Password is re-entered 521 for verification of password entry 420 (FIG. 4). Email address is entered by user in data field 522. Register button 523 submits data to Entity Registration database 113 or 115 (FIG. 1). Other embodiments may instead use separate registration pages for clients and NPOs.

TABLE 1
Non-profit Organization Registration Data Table

| Data Field | Select Box choices | Select Box Choices | Format |
|---|---|---|---|
| Organization Name | | | free form |
| Geographic Service | Texas, ENCentral, | (Texas has another set of | drop down select |
| Region | ESCentral, Mid-Atlantic, | drop down select boxes | box |
| | Mountain, Nationwide, | that include: Dallas/Ft | |
| | New England, Pacific, | Worth Metro, Houston | |
| | So-Atlantic, WNCentral, | Metro, Central TX, | |
| | WSCentral | statewide) | |
| Mission/Organizational | | | free form |
| Description | | | |
| Focus Area(s) | | Non-profit focus area | drop down select |
| | | codes (Refer to Table 2 | box |
| | | for complete listing) | |
| Address | | | free form |
| Phone | | | free form |
| Fax | | | free form |
| Web address | | | free form |
| Federal ID #/EIN | | | free form |
| Leadership name, title | | | free form |
| Contact name, title | | | free form |
| Contact phone | | | free form |
| Contact Email | | | free form |
| Clients | | | |
| Number Served Annually | | | free form |
| Average Age | | <18, 18–35, 36–50, 51–65, | drop down select |
| | | >65 | box |
| Average Annual Family | | <25,000; 25,000–49,999; | drop down select |
| Income | | 50,000–74.999; 75,000–99,999; | box |
| | | 100,000–125,000; | |
| | | >125,000 | |
| English Ability (%) | | | |
| English only | | <20, 21–40, 41–60, 61–80, | drop down select |
| | | 81–100 | box |
| English very well | | <20, 21–40, 41–60, 61–80, | drop down select |
| | | 81–100 | box |
| English less than very | | <20, 21–40, 41–60, 61–80, | drop down select |
| well | | 81–100 | box |
| Educational Attainment | | | |
| (%) | | | |
| <9th grade | | <20, 21–40, 41–60, 61–80, | drop down select |
| | | 81–100 | box |
| 9–12 grade completed | | <20, 21–40, 41–60, 61–80, | drop down select |
| | | 81–100 | box |
| HS grad or GED | | <20, 21–40, 41–60, 61–80, | drop down select |
| | | 81–100 | box |
| some college | | <20, 21–40, 41–60, 61–80, | drop down select |
| | | 81–100 | box |
| college grad | | <20, 21–40, 41–60, 61–80, | drop down select |
| | | 81–100 | box |
| Budget information | | | |
| Fiscal Year Start Date | | | (mm/dd/yyyy) |
| (mm/dd/yyyy) | | | |
| Fiscal Year End Date | | | (mm/dd/yyyy) |
| (mm/dd/yyyy) | | | |
| Operating Budget for | | | free form $ |
| current FY | | | |
| Operating Budget for | | | free form $ |
| previous FY | | | |
| Operating Budget for year | | | free form $ |
| of funding request | | | |
| Program Budget | | | free form $ |
| Fundraising & Admin | | | free form $ |
| % of annual budget used | | | free form % |
| for F&A | | | |
| Donor Profile | | | |
| Avg Age | | <18, 18–35, 36–50, 51–65, | drop down select |
| | | >65 | box |
| Avg Annual Income | | <25,000; 25,000–49,999; | drop down select |
| | | 50,000–74,999; 75,000–99,999; | box |
| | | 100,000–124,999; | |
| | | 125,000–149,999; 150,000–174,999; | |
| | | 175,000–200,000; | |
| | | >200,000 | |
| Avg Annual Gift | | | free form # |
| Current # donors to org | | | free form # |
| Volunteer Profile | | | |
| Avg Age | | <18, 18–35, 36–50, 51–65, | drop down select |
| | | >65 | box |
| Avg Income | | <25000; 25,000–49,999; | drop down select |
| | | 50,000–74,999; 75,000–99,999; | box |
| | | 100,000–124,999; | |
| | | 125,000–149,999; 150,000–174,999; | |
| | | 175,000–200,000; | |
| | | >200,000 | |

Table 1 shows a Non-profit Organization Registration Data Table according to one embodiment of the present invention which may, for example, implement step 215 (FIG. 2). The various data points depicted in Table 1 are preferably entered by non-profits as part of a detailed registration profile. The depicted entries regarding clients are descriptive of the service population served by the non-profit.

TABLE 2
Non-Profit Focus Area Codes Table

| Code | Non-profit Focus Area |
|---|---|
| A | Arts, Culture & Humanities |
| B | Education |
| B20 | Elementary & Secondary Schools (NAICS: 611) |
| B21 | Preschools (NAICS: 611) |
| B60 | Adult Education (NAICS: 611) |
| C | Environment |
| D | Animal-Related |
| E | Health Care |
| F | Mental Health & Crisis Intervention |
| G | Voluntary Health Associations & Medical Disciplines |
| H | Medical Research |
| I | Crime & Legal-Related |
| J | Employment |
| K | Food, Agriculture & Nutrition |
| L | Housing & Shelter |
| M | Public Safety, Disaster Preparedness & Relief |
| N | Recreation & Sports |
| O | Youth Development |
| P | Human Services |
| R | Civil Rights, Social Action & Advocacy |
| S | Community Improvement & Capacity Building |
| T | Philanthropy, Voluntarism & Grantmaking Foundations |
| U | Science & Technology |
| V | Social Science |
| W | Public & Societal Benefit |
| X | Religion-Related |
| Y | Mutual & Membership Benefit |
| Y20 | Insurance Providers (NAICS: 524) |
| Y22 | Local Benevolent Life Insurance Associations, Mutual Irrigation |
| | & Telephone Companies & Like Organizations (NAICS: 524) |
| Y23 | Mutual Insurance Companies & Associations (NAICS: 524) |
| Z | Unknown |

Table 2 shows Profit Focus Area Codes employed in various embodiments. This table, and its categories, is a subset of NTEE codes for non-profits. These codes are the drop down select box menu choices for focus area in Table 1.

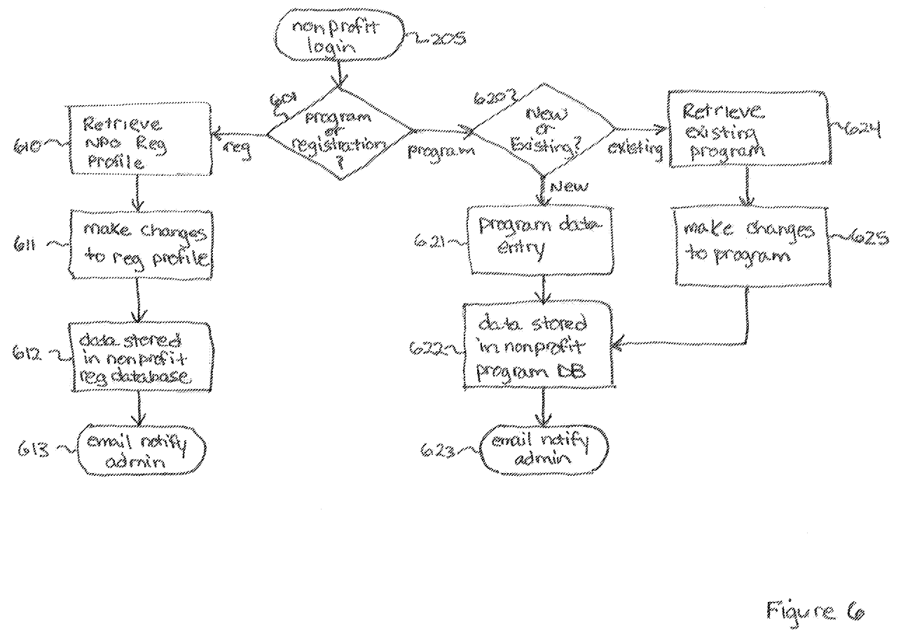

FIG. 6 depicts a flow chart for non-profit login according to one embodiment of the present invention which may, for example, implement the Non-profit segment of step 205 (FIG. 2). The non-profit user logs in and chooses between editing the registration profile and editing/entering a program 601. If registration is chosen, the NPO registration profile will be pulled from the NPO registration database 610. A user may make any edits to the registration profile in step 611. When finished editing, user selects save button and that new information is stored in the non-profit registration database in step 612, replacing the previous version. System 110 generates an email to notify the provider administrator of changes made to registration profile 613.

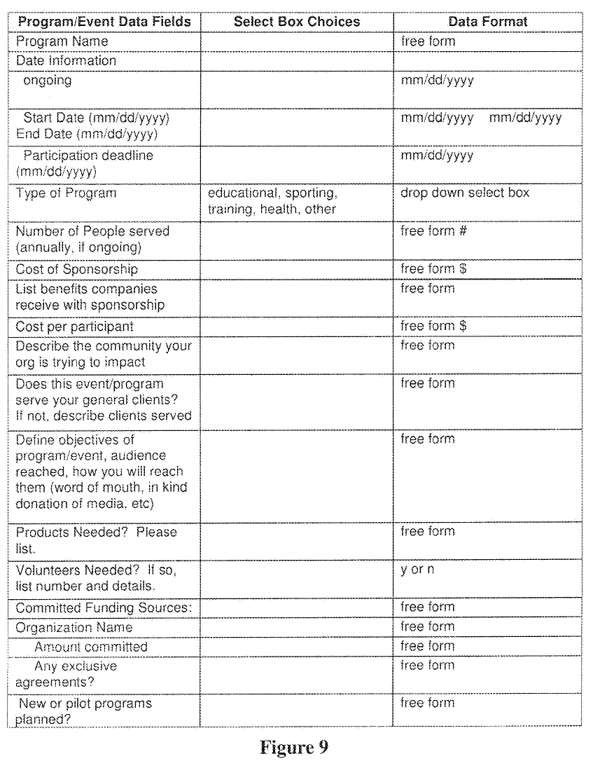

If the non-profit user selects editing/entering a program in step 601, user next chooses between editing an existing Program, chosen from provided listing, or to enter a new program 620. When user selects to enter a New Program, system provides a form (FIG. 9) for user to enter program data in step 621. After data entry is completed user selects save button and that new information is stored in the Non-profit program database 622. Next the system 110 generates an email to notify the provider administrator of new entry in non-profit programs database 623.

If the Non-profit user selects editing/entering a program in step 601, user next chooses between editing an existing program, chosen from provided listing, or to enter a new program in step 620. When user selects to edit an existing program, the NPO program will be retrieved from the NPO program database 624. A user may make any edits to the NPO program (step 625). When finished editing, user selects save button and that new information is stored in the NPO Program database (step 622), replacing the previous version. System generates an email to notify the Trinity Alliance Administrator of changes made to NPO Program database (step 623).

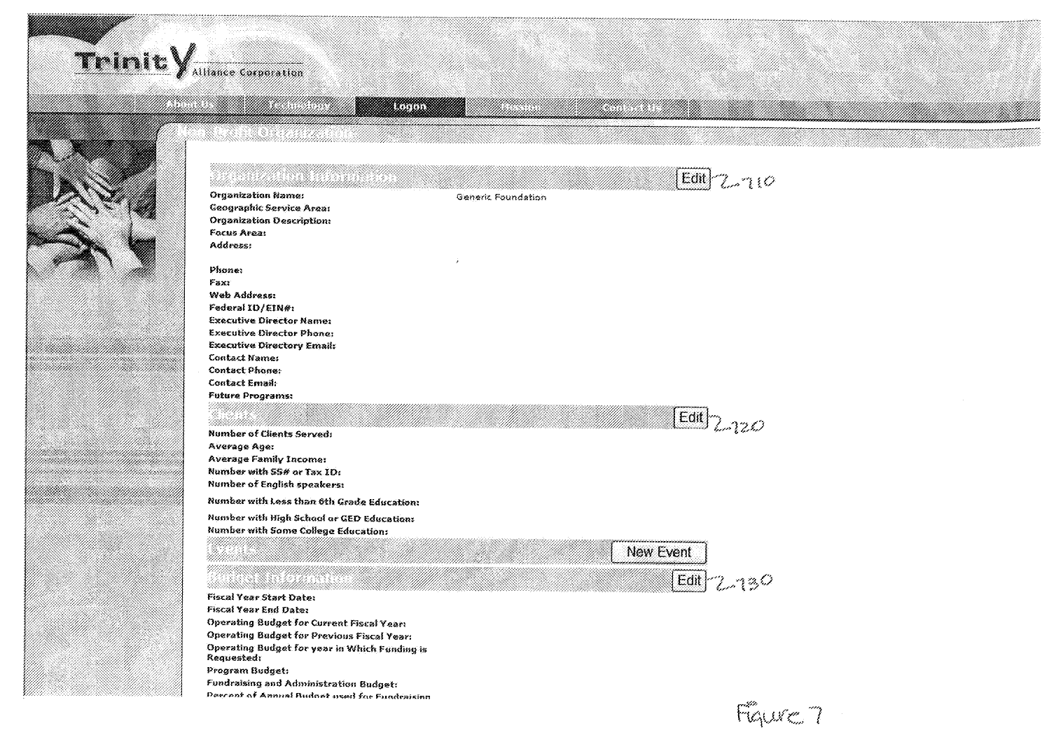

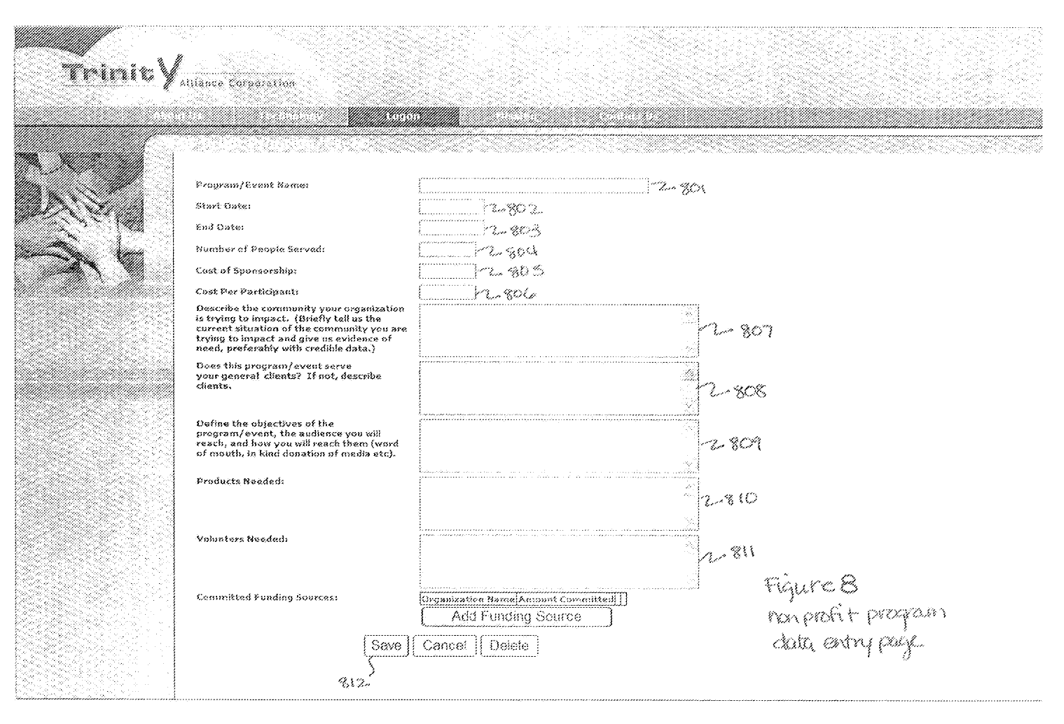

FIG. 7 depicts a web page interface according to one embodiment of the present invention which may, for example, implement steps 221 and 224 (FIG. 2). Implementation of step 224 (FIG. 2) is achieved by buttons 710, 720 and 730. Button 710 allows for the NPO information to be edited and saved in non-profit registration profiles database 113 (FIG. 1). Button 720 allows for the NPO client information to be edited and saved in non-profit registration profiles database 113 (FIG. 1). Button 730 allows for NPO budgetary information changes to be made and saved in non-profit registration profiles database 113 (FIG. 1). Implementation of step 221 (FIG. 2) is achieved by Button 740, which links to an NPO Program/Event input screen (FIG. 8). The depicted profile information may also be employed as the data structure for each database entry used to store the information. Some embodiments may have other database fields not provided to the NPO organization, but instead populated and associated with the NPO by provider administrators or other methods.

The depicted data structures herein may be employed as a standard through which information on advertising and customer relations is transmitted between entities. For example, an advertising client Customer Relations Management (CRM) system may store or produce formatted data regarding particular product marketing campaigns or other publicity campaigns for transmittal to system 110.

FIG. 8 depicts a web page interface according to one embodiment of the present invention which may, for example, implement step 221 (FIG. 2) the data entry page for non-profit program. Text box 801 depicts a free form data entry field where NPO user enters program or event name. Box 802 depicts a free form data entry field where NPO user enters the start date for the program or event, and box 803 depicts a free form data entry field with the ends date of the program or event. An event with less than 24 hour duration may have the same start and end date. Box 804 depicts a free form data entry field where NPO user enters the number of people expected to attend the event or participate in the program. Box 805 depicts a free form data entry field where NPO user may enter the cost of sponsoring a portion of the event. This may be the cost to set up a booth, the cost of underwriting all, or a portion of the event or program, or other costs of sponsorship. Box 806 depicts a free form data entry field where NPO user enters the cost per participant in the event or program, if applicable. For example, there may be a cost associated with a 6 week class being offered, or an entry fee for a season long sporting team, or other costs per participant. Box 807 depicts a free form data entry field where NPO user enters a description of the general community the NPO is trying to reach and impact. Some information included might be, but is not limited to, demographics, previous program results, and needs. Box 808 depicts a free form data entry field where NPO user enters the description of the target audience for this particular program. Again, information included might be, but is not limited to, demographics, previous program results, and needs. Box 809 depicts a free form data entry field where NPO user enters the objective of the event or program such as, but not limited to: target audience, method of delivery, success criteria, or other goals. Box 810 depicts a free form data entry field where NPO user enters information about products that may be needed for the event or program, or products that event or program attendees might sample or use. Box 811 depicts a free form data entry field where NPO user enters information about volunteers that may be needed for the event or program.

The depicted button 812 in FIG. 8 allows all data entered in to boxes 801 thru 811 to be stored in a non-profit program record in the Non-profits Programs database 114 (FIG. 1). These records are “child” record associated with the “parent” NPO registration file. The depicted profile information may also be employed as the data structure for each database entry used to store the program/event information. Some embodiments may have other database fields not provided to the NPO organization, but instead populated and associated with the NPO by provider administrators or other methods, such as automatic population. While in this embodiment a database is used with a MySQL interface, other databases such as Microsoft SQL Server, PostgreSQL, etc may be used and other data storage methods such as Microsoft Internet Information Services (IIS) may be used.

FIG. 9 illustrates an outline format of a sample non-profit organization program profile data form to be filled in by NPO users. This embodiment of step 221 (FIG. 2) uses data entry fields to collect information for NPO programs. Once collected, this information will, be stored in the NPO Programs database 114 (FIG. 1). In other embodiments, NPOs may have capability of entering separate contact information per program. Other versions may also have the capability of auto-populating those data fields with the NPO registration contact information, if NPO user chooses.

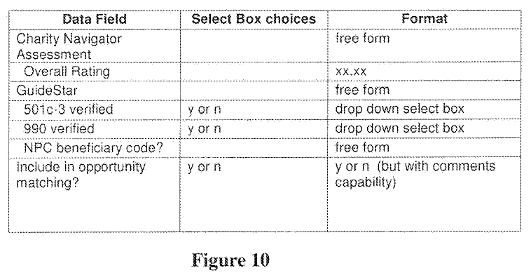

FIG. 10 illustrates an outline format of a sample Trinity Alliance administrator approval of non-profit organization data form to be filled in by administrative users. This embodiment of step 315 (FIG. 3) uses data entry fields to collect information on NPOs. The provider administrator researches the entity to determine suitability for matching based on predetermined guidelines. This information is stored in the NPO registration profiles 113 (FIG. 1).

In other embodiments, data may be automatically retrieved from business partner websites, and suitability for matching automatically calculated and status may be automatically determined and updated therefrom.

TABLE 3
Client Registration Data Table

| Registration Information | | | |
|---|---|---|---|
| Data Fields | Select Box choices | Select Box choices | Format |
| Organization Name | | | free form |
| Organization Geographic | Texas, Nationwide, | (Texas has another set of | drop |
| Service Region | ENCentral, ESCentral, | drop down select box | down |
| | Mid-Atlantic, Mountain, | select boxes that include: | select |
| | New England, Pacific, | Dallas/Ft Worth Metro, | box |
| | So-Atlantic, WNCentral, | Houston Metro, Central | |
| | WSCentral | TX, statewide) | |
| Organizational Focus | financial products & | | drop |
| Area(s) | services, housing, | | down |
| | insurance, health care, | | select |
| | education, media, | | box |
| | consumer products, other | | |
| Organizational Focus Area | | | free form |
| Detail | | | |
| Address | | | free form |
| Phone | | | free form |
| Fax | | | free form |
| Web address | | | free form |
| Leadership name, title | | | free form |
| Contact name, title | | | free form |
| Contact phone | | | free form |
| Contact Email | | | free form |
| Would you like to be | | y or n | drop |
| notified of non-profit | | | down |
| sponsored opportunities | | | select |
| (i.e. classes, services, etc) | | | box |
| to share with your | | | |
| employees? | | | |
| Would you like to be | | y or n | drop |
| notified of volunteer | | | down |
| opportunities for your | | | select |
| employees? | | | box |

Table 3 depicts the client Registration Data Table according to one embodiment of the present invention which may, for example, implement step 211 (FIG. 2).

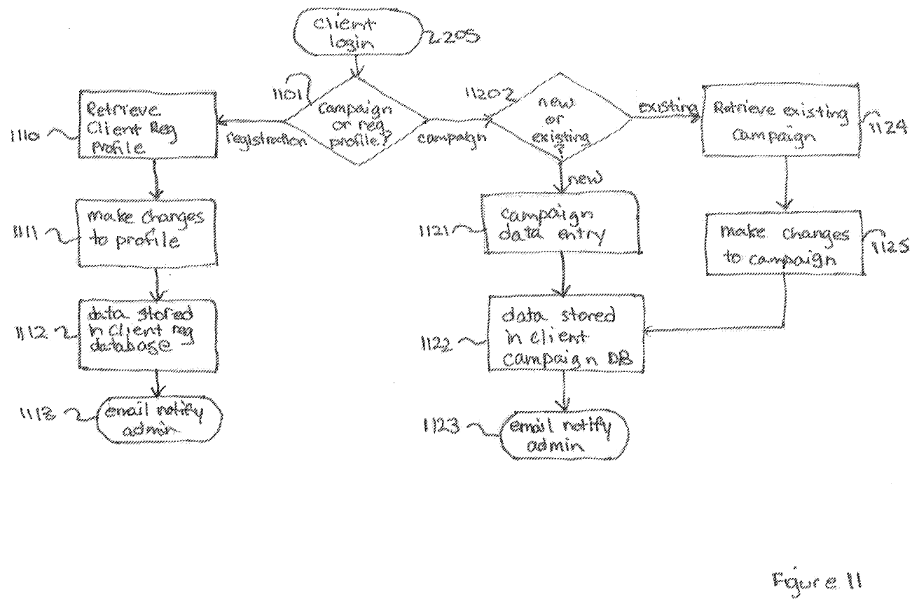

FIG. 11 depicts a flow chart for client login and use according to one embodiment of the present invention which may, for example, implement the client segment of step 205 (FIG. 2). The client user logs in and chooses between editing the registration profile and editing/entering a campaign (step 1101). If registration is chosen, the client registration profile will be pulled from the client registration database (step 1110). The client user may make any edits to the registration profile (step 1111). When finished editing, the client user selects save button and that new-information is stored in the client registration database (step 1112), replacing the previous version. System 110 then generates an email to notify the provider administrators of changes made to registration profile (step 1113).

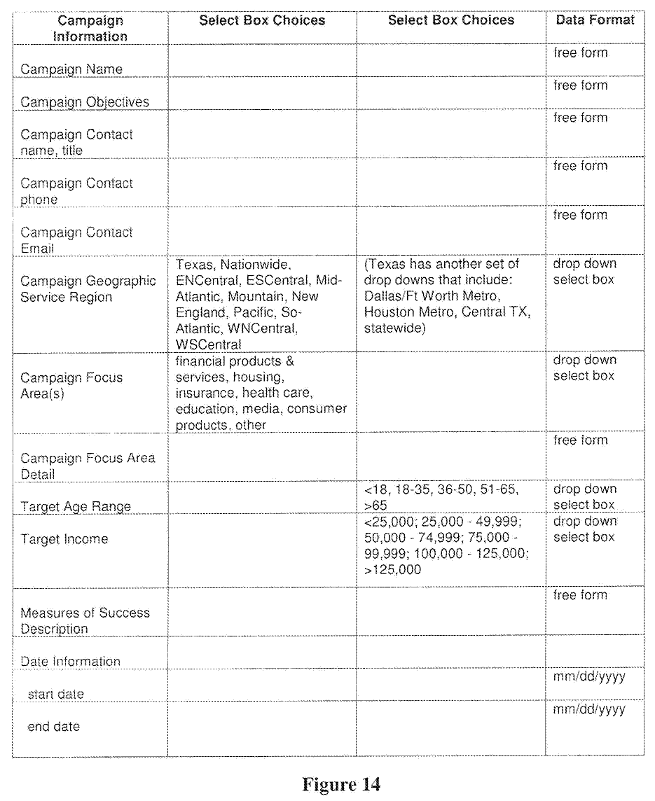

If the client user selects editing/entering a campaign in step 1101, the user next chooses between editing an existing campaign, chosen from provided listing, or to enter a new campaign (step 1120). When the user selects to enter a new campaign, system provides a form (FIG. 14) for user to enter campaign data (step 1121). After data entry is completed the user selects save button and that new information is stored in the client campaign database (step 1122). System generates an email to notify the provider administrator of new entry in client campaign database (step 1123).

When user selects to edit an existing campaign (step 1120), the client campaign will be retrieved from the client campaign database (step 1124). The client user may make any edits to the client campaign (step 1125). When finished editing, user selects save button and that new information is stored in the client campaign database (step 1122), replacing the previous version. System 110 then generates an email to notify the provider administrator of changes made to client campaign database (step 1123).

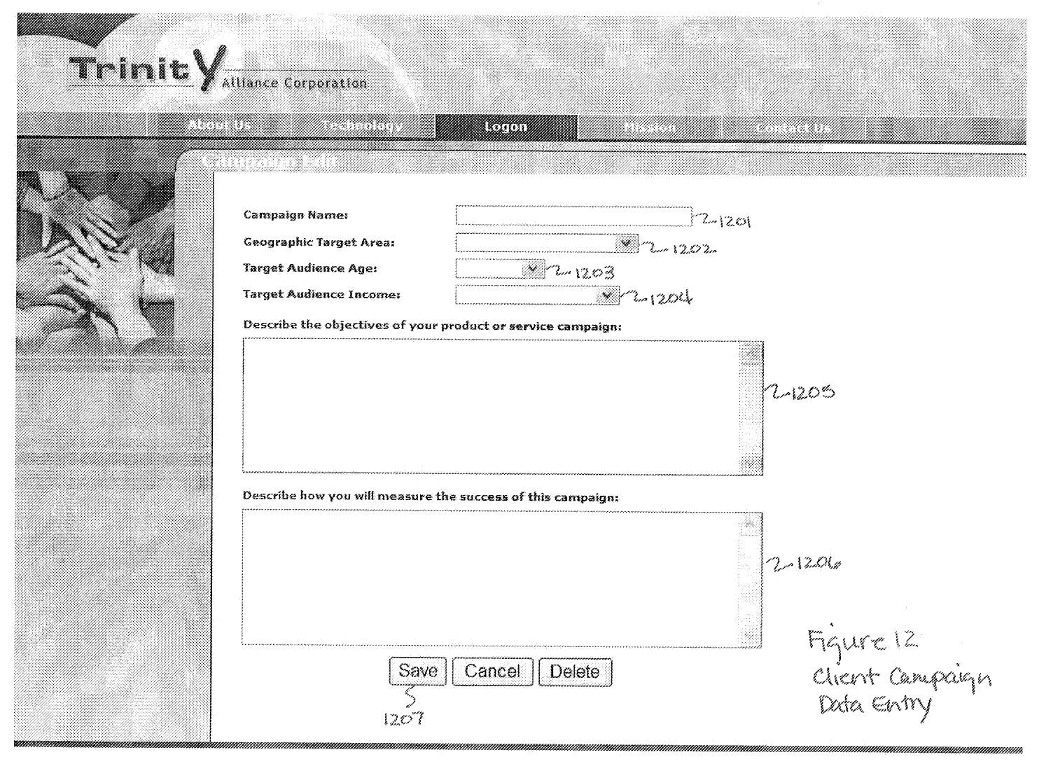

FIG. 12 depicts a web page interface according to one embodiment of the present invention which may, for example, be employed in steps 231 and 233 (FIG. 2), the data entry and edit pages for client Campaigns. Text box 1201 depicts a free form data entry field where client user enters the Campaign Name. Box 1202 depicts a select box data entry field where client user selects the Geographic Region that the campaign is targeting. Box 1203 depicts a select box data entry field where client user selects the age range of the audience that the campaign is targeting. Box 1204 depicts a select box data entry field where client user selects the annual income of the audience that the campaign is targeting.

Text box 1205 depicts a free form data entry field where client user enters the description of the product or service for this particular campaign. Information included might be, but is not limited to, demographic information requests, target audience profiles, goals and objectives, previous campaign results, and needs. Box 1206 depicts a free form data entry field where client user enters the success criteria of the campaign such as, but not limited to: target audience numbers reached, media pick-ups, leads generated, product samples delivery, and other potential success criteria.

The depicted button 1207 in FIG. 12 allows all data entered in to boxes 1201 thru 1206 to be stored in a client Campaign record in the client Campaign database 116 (FIG. 1). These records are “child” records associated with the “parent” client Registration file. While in this embodiment a database is used with a MySQL interface, other databases such as Microsoft SQL Server, PostgreSQL, etc may be used and other data storage methods such as Microsoft Internet Information Services (IIS) may be used.

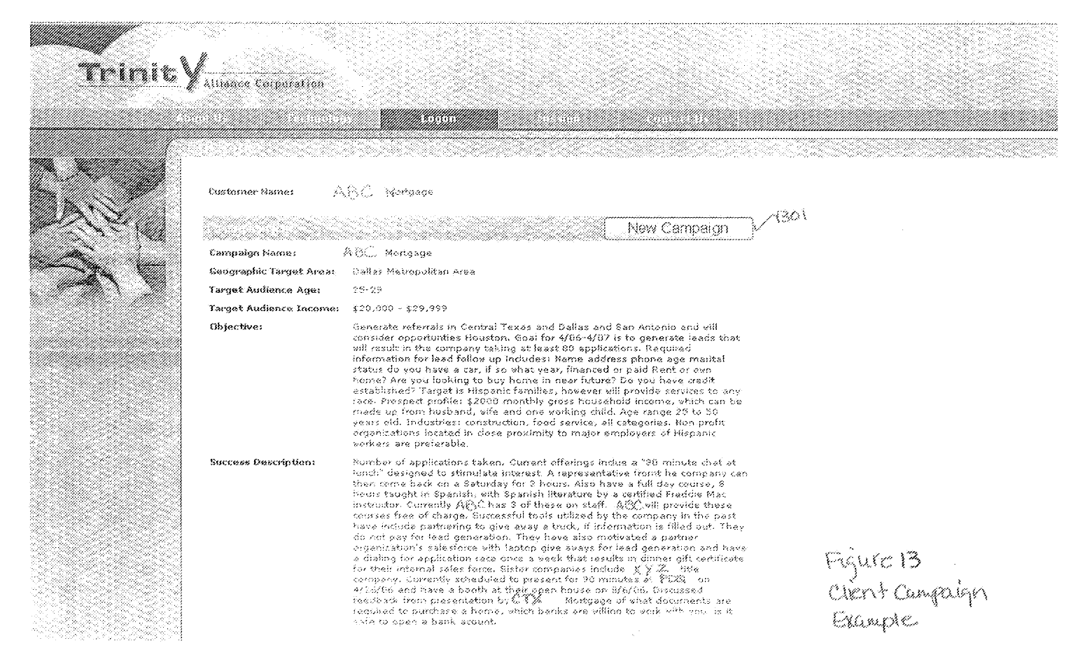

FIG. 13 depicts a web page interface according to one embodiment of the present invention which may, for example, display a campaign chosen from a campaigns list 232 (FIG. 2). Button 1301 links user back to FIG. 12 and possible new campaign data entry.

FIG. 14 illustrates an outline format of a sample client campaign profile data form to be filled in by client users. This implementation of step 231 (FIG. 2) uses data entry fields to collect information for client campaigns. Once collected, this information is preferably stored in the client campaigns database 116 (FIG. 1). The depicted table form may also illustrate the data structure in which the entered data is stored. Other fields may also be included in the data structure.

In other embodiments, the client profile may include an access level indicator to allow access to premium features or data. Each client campaign may then have an “access level indictor” as part of the data structure. Similarly, the NPO programs database may have additional demographic or other data as part of its data structure. In still other variations, client may have capability of entering separate contact information per campaign. Some versions may also have the capability of auto-populating those data fields with the client registration contact information, if the client user chooses.

FIG. 15 depicts a flow chart of a central matching application which connects client campaigns with non-profit organization profiles on the basis of a highly configurable search function according to one embodiment of the present invention. Such a matching application may, for example, be employed to implement the non-profit segment of step 256 (FIG. 2). While a software application is described, one of skill will understand that the functionality described herein may be part of a software subroutine or method employed in a larger application, or may be embodied by separate executable code (running in separate processes from other system functionality) which may communicate with shared variables, files, or inter-thread messaging, for example. A preferred embodiment employs advanced queries for searching SQL databases for matching terms. The typical SQL application, such as the MySQL application, has a searching code segment for searching the application for performing structured search queries. Such an application is known in the art and considered associated with the databases depicted, for example, in FIG. 1. Other databases have searching applications similarly associated thereto. Search queries may be formatted and submitted through scripts or other code provided in the server engine 111 through its associated web pages 112. Other embodiments may use a separate query interface program to generate queries for database searching.

In this embodiment, the depicted application starts with an NPO program and looks to match multiple client campaigns with it. The preferred software is a single, highly configurable matching program with multiple optional parameters. In some instances, this search will be used by the provider administrator, who will then forward a resulting report to the NPO. In other embodiments, the same matching program may be provided to the NPO users and client users of system 110, and some options may at that time be “hard coded” into the search to restrict its function to that relevant to users. In either case, the web servers employed on system 110 may present an interface to the search program using known web interface methods for SQL or other database engines that may be employed. Preferably, the matching program is an advanced search query, based on an initial or target profile to be matched, and the definition of the search will be determined by processing the form.

In order to set up the search parameters, the selection of the target program profile is selected in step 256 (FIG. 2) by selecting a particular program record and clicking a “Find Matches” button to find matches for that program. In step 1501, the type of match is selected by choosing one of the following from a select (dropdown) box: Find Matching Programs, Find Matching Campaign, Find All Matches. If geographic region filters need to be applied 1502, then select US region (from dropdown list) In step 1503. NPO event records may also be used to start the depicted search process.

In the depicted embodiment, where more system clients reside in Texas, if the region selected is within TX (step 1504), there is the potential for selecting geographic region detail. There are four (4) Texas (TX) regions and one default if the region is not within Texas. The matching program user selects TX Region (from dropdown list) in step 1505. Other divisions and regions may, of course, be used.

Step 1506 is a date range filter. The user selects the participation date range filter parameters, which may be constructed with select boxes for each month, date, and year to avoid the possibility of an invalid date. First selection option is Begin Date, which may default to “Today's date” if left empty, and then End Date. If “End Date” is left blank, a future date such as Dec. 31, 2010 may be used by default. This should be the same as having no date filter. Preferably, this match process will present any profiles with even 1 day of overlap in the date range. The relevant field for this search is participation deadline, which means essentially the “sign-up deadline” and does not refer to the dates of the actual program or campaign. If the begin date is after the end date, the error may be trapped and the user returned to the form.

Step 1507 refers to client category filters. Client categories may be selected from a dropdown list of several choices in step 1508, This categorization matches to the directly entered category for campaigns. “Other” is to be treated like any other category.

Step 1509 is a Volunteers Needed filter. This is a directional match with a Y/N crossover. Volunteer matching may be selected from a dropdown list of two (2) choices in step 1510. The volunteers needed filter finds campaigns that have identified that volunteers, typically from the company sponsoring the campaign, are available to help with the program if a sponsor relationship is eventually formed based on the matching process. If an NPO is searching to match campaigns with a program requiring no volunteers, they might search for campaigns that have volunteers, or no volunteers, or both. A program requiring volunteers may search for campaigns that have volunteers available.

Steps 1501 through 1510 determine the match results returned from the matching process. The order in which they will be returned is determined by sorting. Step 1511 allows the user to indicate the primary sort order of the match results. The user may choose from four options in a select box. Step 1512 allows the user to indicate the secondary sort order of the match results. The user may choose from four options in a select box. The results of the current matches are then stored in the current matches database 117 (FIG. 1).

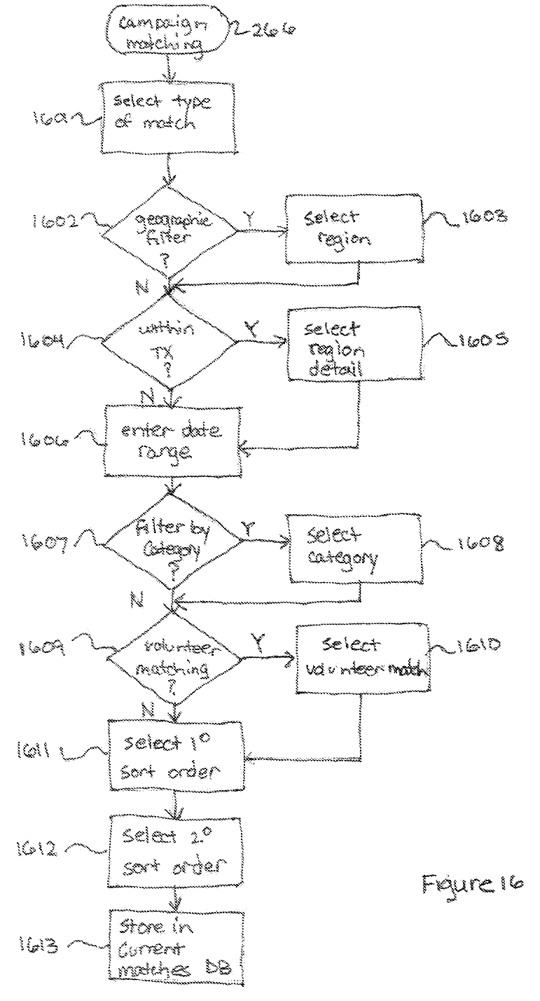

The search query is typically initiated after ail the search parameters are entered in steps 256 through 1510. Different embodiments may perform the actual database search before or after the sort order is entered, or may present an option to execute the search after any particular parameter is entered to narrow down results or determined how many search results are present. In one embodiment, a keyword search may be entered along with the parameters shown in FIG. 16. In another embodiment, search parameters are also pulled from one or more of the parameters already entered into the NPO program being matched. For example, the program data entered (FIG. 6 and FIG. 8) may be used to populate search terms in the search query. Some embodiments may present the list of program characteristics such as those depicted in FIG. 8 for a user to select one or more of those characteristics to be search parameters.

In other embodiments, text search capability may scan the “Committed Funding Sources” section of the NPO program file and compare against the list of potential clients. Any matches between “Committed Funding Sources” and potential clients may automatically result in elimination of that client and ail associated Campaigns from the NPO program matches list, and also that NPO Program from the client campaign matches list. Those matches, without previously committed funding sources, may then be stored in the current matches database. Typically, the current matches database has campaign matches that are associated with the specific program or even for which matches are desired.

FIG. 16 depicts a flow chart for a central matching application to connect client campaigns with non-profit organization profiles on the basis of a highly configurable search function according to one embodiment of the present invention. The depicted design may, for example, implement the client campaign segment of step 266 (FIG. 2). The depicted process proceeds much as that in FIG. 15, but in this embodiment the matching process starts with an advertising campaign and look to match multiple NPO programs with it, Resulting matches are typically delivered to an advertising client. The software may be architected as described above.

In order to set up the search parameters, the selection of the target program profile is selected 266 (FIG. 2) by clicking the “Find Matches” button. In step 1601, the type of match is selected by choosing one of the following from a select (dropdown) box: Find Matching Programs, Find Matching Campaign, Find All Matches. If geographic region filters need to be applied 1602, the user then selects US region (from dropdown list) in step 1603.

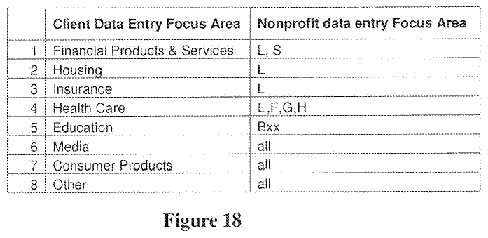

Step 1606 is a date range filter. Step 1607 refers to category filters. This categorization is the directly entered Category for Campaigns, but for Programs is not directly entered and must be derived from the NTEE codes (Table 2) for Programs. The derivation is based on a direct mapping table (FIG. 18), which is a “many-to-many” type of correspondence. “Other” is to be treated like any other category, client categories may be selected from a dropdown list of choices in step 1608. This categorization is the directly entered category for campaigns. “Other” is to be treated like any other category.

Step 1609 is a “Volunteers Requested” filter. This is a directional match with a Y/N crossover. Volunteer matching may be selected from a dropdown list of two (2) choices in step 1610. In this embodiment of the matching process, the volunteers requested filter is operated by or for the advertising clients who are potential sponsors of the programs or events that the search will identify. The volunteer requested filter therefore identifies programs or events that have requested volunteers to help operate the program or event. If the advertising client has volunteers available, they might search for a program needing volunteers, or not, or both.

Steps 1601 through 1610 determine the results returned from the matching process. The order in which they will be returned is determined by sorting. Step 1611 allows the user to indicate the primary sort order of the match results. The user may choose from four options in a select box. Step 1612 allows the user to indicate the secondary sort order of the match results. The results of the current matches are then stored in the Current Matches database 117 (FIG. 1). Typically, the current matches database has program matches that are associated with the specific campaign for which matches are desired.

The search query is typically initiated after ail the search parameters are entered in steps 266 through 1610. Different embodiments may perform the actual database search before or after the sort order is entered, or may present an option to execute the search after any particular parameter is entered to narrow down results or determined how many search results are present. In one embodiment, a keyword search may be entered along with the parameters shown in FIG. 16. In another embodiment, search parameters are also pulled from one or more of the parameters already entered into the client campaign being matched. For example, the campaign data entered (FIG. 11 and FIG. 12) may be used to populate search terms in the search query. Some embodiments may present the list of campaign characteristics such as those depicted in FIG. 12 for a user to select one or more of those characteristics to be search parameters.

In other embodiments, text search capability may scan the “Committed Funding Sources” section of the NPO Program file and compare against the list of potential clients. Any matches between “Committed Funding Sources” and potential clients may automatically result in elimination of that client and all associated campaigns from the NPO program matches list, and also that NPO Program from the client campaign matches list. Those matches, without previously committed funding sources, may then be stored in the current matches database.

Program matches from the depicted search process are then generated and transmitted in some form to the requesting advertising client. Some embodiments may employ provider administrators to operate the search, edit search results reports, and transmit the reports to the clients. Similar functions may be provided for the NPO searches (FIG. 15).

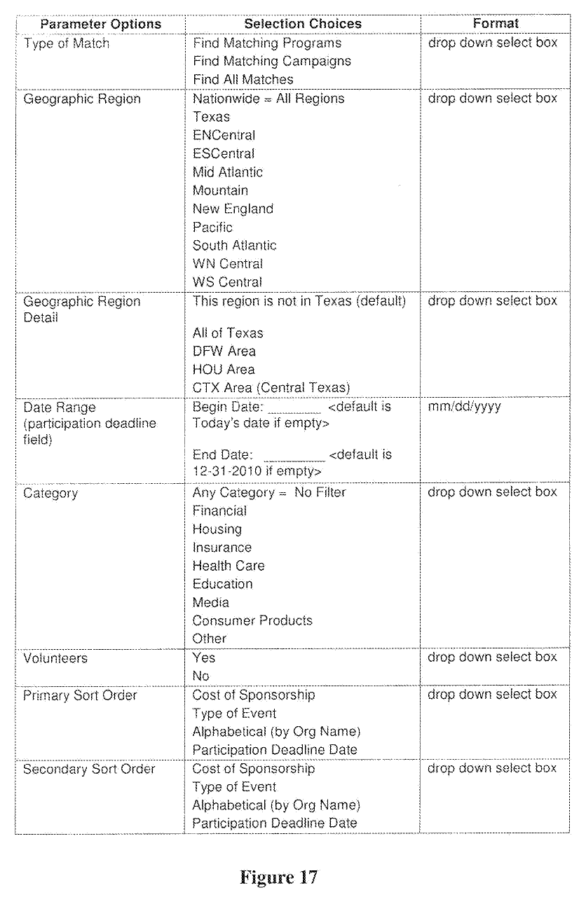

FIG. 17 illustrates an outline format of a sample Matching Program Parameters Data form. Selections and entries in this form may be made by provider administrator during the matching process (in some embodiments), with results then provided to the clients, or by client users themselves (in other embodiments). The depicted table format may be employed as the data structure in which the entered data is stored. This version of steps 256 and 266 (FIG. 2) uses a combination of select boxes and data entry fields to choose which fields, and which values in those fields, may be used in the matching process. The results of the current matches are then stored in the Current Matches database 117 (FIG. 1).

FIG. 18 illustrates a supporting mapping table between directly entered categories for client campaigns and directly entered NTEE codes for NPO Programs according to one embodiment of the present invention. Such a mapping table may be employed, for example, to implement step 1607. The derivation is based on a direct mapping table, which is a “many-to-many” type of correspondence. “Other” is to be treated like any other category.

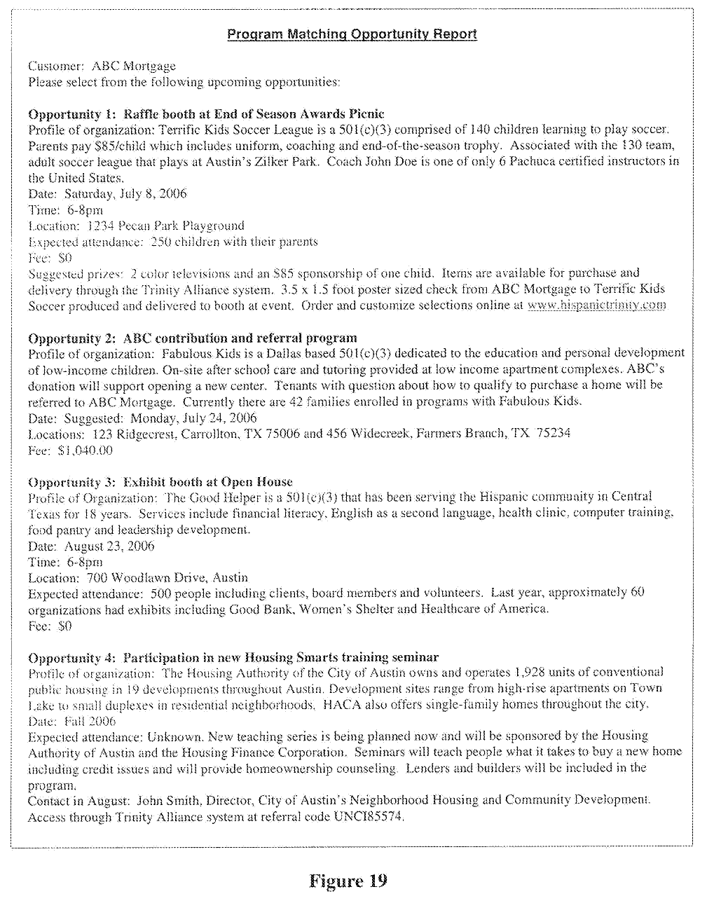

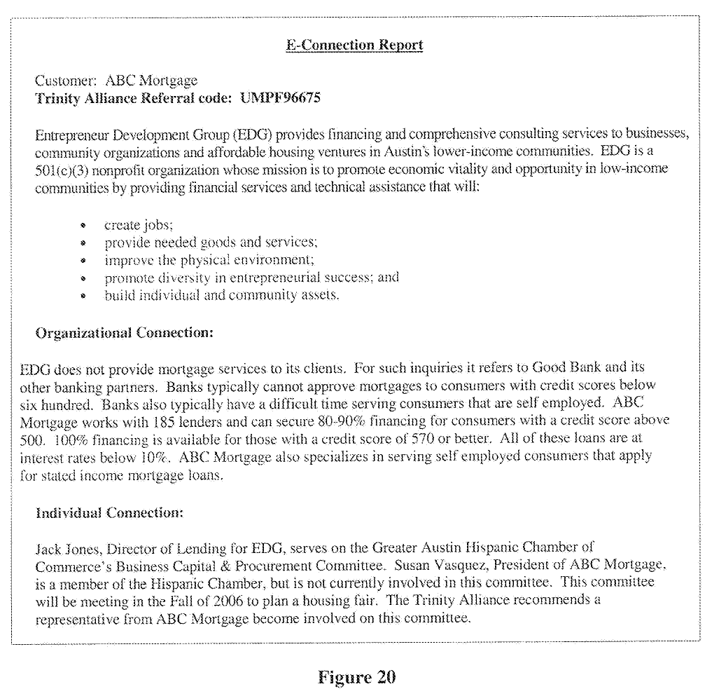

Examples of some matching combinations include, but are not limited to:
Program Matching: Choose a campaign to be matched from the campaign list, select “Find Matching Programs”, Select Geographical Region (and Region Detail if applicable) to correspond with the Campaign Target Geographical Area, Enter Date Range (for example, the next 90 days), do not select any other filter. Sort order can be chosen to be any of the orders, based on user knowledge of client preferences. Sample output may be listing of programs, with select link for program detail. In this embodiment, the information will be transferred into a suitable delivery format such as an MS Word document form to be emailed to the client (FIG. 19). In some embodiments, these reports may be automatically generated by provider administrator, or client user or NPO user, in another word processing package or Portable Document Format (PDF) or other format. A reporting code segment may be installed on the system 110 or operably coupled thereto to format search results and produce a report. For example, the server engine may provide such functionality to present formatted web pages of database search results. Other programs may produce MS Word, PDF, or other report formats. Reports may also be generated from other data stored on system 110. For example, real time data may be made available to each advertiser registered with system 110 about event attendance, reward redemption, leads, sales generated, aggregate prescription patterns, online applications, policy renewals as well as how products are being used by target population consumers.
E-Connections Matching: Choose the Programs List 251 (FIG. 2) and create listing of NPOs by Focus area. Choose the client List 261 (FIG. 2) and create listing of clients by Category. Scan listings for organizational and individual connections. In this embodiment, the information will be transferred into suitable an MS Word document form to be emailed to the client (FIG. 20). In other versions, these reports may be automatically generated by provider administrator, or client user or NPO user, in another word processing package or Portable Document Format (PDF) or other format. In other versions, keyword searches may be used to match on a more comprehensive and targeted level.
Volunteer Opportunity Matching: Choose Program to be matched from the Program List, Select “Find Matching Campaigns”, Select appropriate Geographical Region (and Region Detail if applicable), Enter Date Range (for example, the next 90 days), and Select “Y” for Volunteer Matching, In this embodiment, the information will be transferred into a suitable delivery format such as an MS Word document form to be emailed to the client or NPO. In other versions, these reports may be automatically generated by Trinity Alliance Administrator, or client user or NPO user, in another word processing package or Portable Document Format (PDF) or other format.
Best Practices Matching: Choose the Programs List 251 (FIG. 2) and create listing of NPOs by Focus area. Scan the NPO Mission/Organizational Visions for overlap in key areas of service. Similar to the E-connections Matching between clients and NPOs, scan listings for organizational and individual connections. In this embodiment of the present invention, the information will be transferred into an MS Word document form to be emailed to the NPOs. In other versions, these reports may be automatically generated by Trinity Alliance Administrator, or client user or NPO user, in another word processing package or Portable Document Format (PDF) or other format. In other version of the technology, Keyword searches may be used to match on a more comprehensive and targeted level.

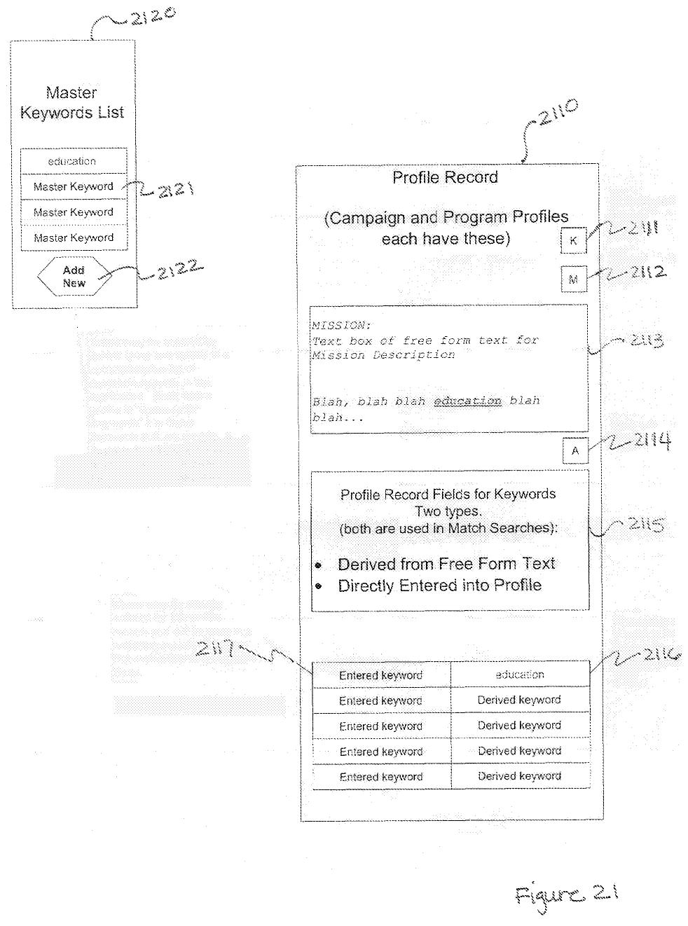

FIG. 21 is a block diagram of an Entity Profile Record. In some embodiments, portions of the profile matching, referenced in FIGS. 15-19 may be enhanced by implementing key word searches in free-form text. In this embodiment, a Profile Record (campaign or program) 2110 has keywords associated with it, in addition to the select box data entries. Button 2111 may initiate the scan of free form text 2113 in the profile for keywords, storing them in the Profile Record Fields for Keywords 2115, within the Profile database (114 or 116). Item 2116 depicts a keyword table of derived and entered keywords. The derived keywords are found in the freeform text description and also the Master Keyword List 2120, The entered keywords 2117 may be directly entered into the table via button 2114 access of the table, for the specific profile records and will be used in a matching search. They are not overwritten in a keyword scan. Button 2112 may initiate an implementation, or partial implementation of the matching process referenced in FIGS. 15-18.

Depicted box 2120 in FIG. 21 illustrates a Master Keywords listing and entry box. The listing may be comprised of master keywords 2121 entered by the provider administrators, resulting in a comprehensive list of covered keywords in the application. If these words are also found in the free form text of a profile record, they may be entered as a derived keyword in the profile record field. Button 2122 may initiate entry of keywords into the Master Keyword Listing by the provider administrators. In a other embodiment, integration of a third party thesaurus may be used to enhance the Master Keywords listing.

Although the present invention has been described in terms of particular embodiments, it is not intended that this invention be limited to those embodiments. It will be understood that various modifications may be made without departing from the spirit and scope of the invention. Thus, the claims, and not the specification, define the scope of the invention. Other embodiments are within the scope of what may be claimed.

What is claimed is:

1. A method of providing advertising opportunity matching services comprising:
receiving from a first advertising user one or more first indicators of one or more target demographic descriptors;
receiving a second indicator of a target marketing date range;
searching at least one database for non-profit organization advertising opportunity records having matched characteristics to the first and second indicators;
transmitting one or more search result records for display to the first advertising user;
receiving a third indicator of a selected non-profit organization advertising opportunity; and
storing a record of the selected non-profit organization advertising opportunity.

2. The method of claim 1 further comprising receiving a fourth Indicator of a target geographic area, and in which the step of searching further comprises searching for non-profit organization advertising opportunity records having matched characteristics to the first, second, and fourth indicators.

3. The method of claim 1 in which the non-profit organization advertising opportunity records are records related to non-profit organization events.

4. The method of claim 1 in which the non-profit organization advertising opportunity records are records related to non-profit organization programs.

5. The method of claim 1 in which the non-profit organization advertising opportunity records are records related to non-profit organization events and programs.

6. The method of claim 1 in which the step of searching is performed by a provider administrative user operating a search application.

7. The method of claim 1 in which the step of searching is performed by a matching code segment in response to receiving a request from the first advertising user.

8. The method of claim 1 further comprising storing the one or more first indicators of target demographic descriptors and the second indicator of a target marketing date range in an advertising campaign data structure.

9. The method of claim 1 in which the step of searching at least one database for non-profit organization advertising opportunity records having matched characteristics further comprises looking up characteristic equivalent values in a mapping table.

10. A computer readable medium storing computer executable instructions for performing the steps of claim 1.

11. A method of providing advertising opportunity matching services comprising:
receiving from a first non-profit organization user one or more first indicators of one or more desired campaign date ranges;
searching at least one database for advertising client campaign records having matched characteristics to the first indicators;
transmitting one or more search result records for display to the first user or a second user;
storing a record of the search result records in a current matches database.

12. The method of claim 11 further comprising receiving from the first non-profit organization user one or more second indicators of a category and in which the step of searching further comprises searching for advertising client campaign records having matched characteristics to the second indicators,

13. The method of claim 11 further comprising applying a committed funding sources filter to the one or more search result records to remove records from already committed funding sources.

14. The method of claim 11 further comprising generating a first search result report containing at least one selected result of the one or more search result records.

15. The method of claim 11 further comprising applying a volunteers needed filter to the one or more search result records to remove records without a desired volunteer requirement.

16. The method of claim 11 further comprising receiving from the first non-profit organization user one or more second indicators of one or more service population demographic descriptors and In which the step of searching further comprises searching for advertising client campaign records having matched characteristics to the second indicators.

17. An information system comprising:
a server system connected to a computer network;
a database software module installed on, or operably coupled to, the server system, the database software module storing one or more advertising client campaign records and one or more non-profit organization program records;
a searching code segment operably associated with the database software module and operable to receive search parameters and provide a selected one or more of the non-profit organization program records that match the search parameters.

18. The information system of claim 17, in which the database software module stores the selected one or more matching non-profit organization program records in a current matches database.

19. The information system of claim 17, further comprising a reporting code segment operable to format a report of the selected one or more of the non-profit organization program records that match the search parameters.

20. The information system of claim 17, further comprising one or more web page records for presenting, from a server engine in the server system, one or more registration or data entry pages for providing data to the database software module.

21. The information system of claim 17 in which the searching code segment is operable to receive one or more keywords to further limit search results to non-profit organization program records that contain the one or more keywords.

22. The information system of claim 17 in which the searching code segment is operable to extract one or more of the search parameters from a selected one of the one or more advertising client campaign records.

23. An information system comprising:
a server system connected to a computer network;
a database software module installed on, or operably coupled to, the server system, the database software module storing one or more advertising client campaign records and one or more non-profit organization program records;
a searching code segment operably associated with the database software module and operable to receive search parameters and identify a selected one or more of the advertising client campaign records that match the search parameters.

24. The information system of claim 23, in which the database software module stores the selected one or more matching advertising client campaign records in a current matches database.

25. The information system, of claim 23, further comprising a reporting code segment operable to format a report of the selected one or more of the advertising client campaign records that match, the search parameters.

26. The information system of claim 23, further comprising one or more web page records for presenting, from a server engine in the server system, one or more registration or data entry pages for providing data to the database software module.
